(19) United States
(12) Patent Application Publication
(10) Pub. No.: US 2023/0310909 A1
(43) Pub. Date: Oct. 5, 2023

(54) 3D PRINTING-BASED FACE MASK

(71) Applicant: Cafe24 Corp., Seoul (KR)

(72) Inventor: Jae Suk LEE, Seoul (KR)

(73) Assignee: Cafe24 Corp., Seoul (KR)

(21) Appl. No.: 18/021,183

(22) PCT Filed: Aug. 3, 2021
(86) PCT No.: PCT/KR2021/010184

§ 371 Date: Feb. 14, 2023

(30) Foreign Application Priority Data
Aug. 14, 2020 (KR) 10-2020-0102651
Aug. 3, 2021 (KR) 10-2021-0101786
Aug. 3, 2021 (KR) 10-2021-0101787
Aug. 3, 2021 (KR) 10-2021-0101788
Aug. 3, 2021 (KR) 10-2021-0101789

(51) Int. Cl. A62B 18/02; A41D 13/11; A62B 23/06; A62B 23/02; B33Y 80/00

(52) U.S. Cl. CPC A62B 18/025; A41D 13/11; A62B 23/06; A62B 23/02; B33Y 80/00; A62B 18/084

(57) ABSTRACT

A 3D printing-based face mask is disclosed. The face mask may comprise: a mask body which corresponds to the shape of the lower portion of a user's face and displays the shape of the user's lower portion on the outer surface thereof; at least one filter part which is mounted on at least one side of the mask body; and ear hanging parts for fixing the mask body on the user's ears. The mask body can be generated by 3D printing based on a 3D mask model corresponding to the shape of the lower portion of the face, including the lower part of the user's nose and mouth, and the at least one filter unit is mounted in correspondence with at least one of the lower part of the nose and the mouth. Accordingly, the user can wear the mask without aesthetic texture.

### BACKGROUND

### Field

The present disclosure relates to a 3D printing-based face-shaped mask, and more particularly, to a 3D printing-based face-shaped mask which is dustproof and capable of preventing infection with contagious bacteria while being formed in a shape identical to a human face based on 3D printing.

### Related Art

Recently, due to increase in yellow dust and fine dust, the number of people who suffer from respiratory diseases such as rhinitis, bronchitis, and lung diseases is increasing. For example, rhinitis is caused by damage to the nasal mucosa through immunity, body heat imbalance, intestines, and toxins, and symptoms such as nasal congestion, sneezing, runny nose, headache, and hyposmia appear.

In addition, coronavirus infection, a respiratory infectious disease caused by a new type of coronavirus that has spread throughout China and around the world since first occurring in Wuhan, China in December 2019, is infected when droplets of an infected person penetrate respiratory organs or mucous membranes of the eyes, nose, and mouth, and after an incubation period of about 2 to 14 days, respiratory symptoms such as high fever, cough or shortness of breath, and pneumonia symptoms appear.

Accordingly, various measures are being sought to prevent and eradicate these corona, yellow dust, fine dust, and the like. Masks are considered the most basic and effective means to protect humans from coronavirus, fine dust and yellow dust.

In general, a mask used is configured to be worn by covering a lower part of the face using a fiber material such as cotton. However, when such a general mask is worn, it makes the wearer feel stuffy and covers the wearer's face, it is true that people especially in Europe or the Americas, where the face is regarded as their identity, are reluctant to wear the mask. Accordingly, the development of a new type of mask capable of solving this problem is urgently required.

### SUMMARY

In view of the above, the present disclosure provides a 3D printing-based face-shaped mask which is dustproof and capable of preventing infection with contagious bacteria while being formed in a shape identical to a human face based on 3D printing.

According to an aspect of the present disclosure, there is provided a face-shaped mask. The face-shaped mask includes: a mask body which corresponds to a shape of a lower part of a face of a user and displays the shape of the lower part of the user's face on an outer surface thereof; at least one filter unit mounted on at least one side of the mask body; and an earring part configured to fix the mask body to the ears of the user. The mask body is created by 3D printing based on a 3D mask model corresponding to the shape of the lower part of the user's face including a lower part of the nose and the mouth of the user, and the at least one filter unit is mounted to correspond to at least one of the lower part of the nose and the mouth.

The filter unit may include a first filter unit, and a first filter unit mounting portion to which the first filter unit is mounted may be formed at a position corresponding to at least a nostril of the mask body. The first filter unit may be detachably mounted to the first filter unit mounting portion. The first filter unit may be mounted on the mask body through any one of interference fit, screw coupling, and sliding coupling to the first filter unit mounting portion.

The first filter unit may include: a right nostril filter unit corresponding to a right nostril of the mask body; and a left nostril filter unit corresponding to a left nostril of the mask body. The mask body may include: a right nostril filter unit mounting portion for mounting the right nostril filter unit; and a left nostril filter unit mounting portion for mounting the left nostril filter unit.

The filter unit may further include a second filter unit, and a second filter unit mounting portion for mounting the second filter unit may be formed at a position corresponding to a mouth part of the mask body. The second filter unit may be detachably mounted to the second filter unit mounting portion.

The second filter unit may be mounted on the mask body through any one of interference fit coupling, screw coupling, Velcro coupling, snap-fit coupling and sliding coupling to the first filter unit mounting portion.

The at least one filter unit may include a filter, mounted on a portion related to breathing in user's face, which has breathability and blocks at least one of droplets, yellow dust, smoke, toxic gas, fine dust, and viruses from entering the body of the user.

The 3D mask model may be generated by the 3D modeling of receiving a plurality of 2D images obtained by capturing the user's face and converting the received plurality of 2D images into 3D images.

The plurality of 2D images may be received by receiving, from a user terminal, access information to a SNS server corresponding to an account of the user, and collecting the plurality of 2D images including the user's face from the SNS server corresponding to the user's account.

the plurality of 2D images may be received by receiving, from a user terminal, a 2D image including the user's face that is captured in real time or that is previously captured and stored in the user terminal. The plurality of 2D images may include a front view image, a left side view image, and a right side view image of the user.

The 3D mask model may be generated by extracting a plurality of feature points corresponding to the user's face from the plurality of 2D images received, transforming a reference 3D facial model to a 3D facial model corresponding the user's face based on the plurality of feature points extracted, and separating a part corresponding to the shape of the lower part of the user's face from the 3D facial model corresponding to the user's face.

The face-shaped mask may further include a contact portion formed along an inner peripheral surface of the mask body, the contact portion being in close contact with the user's face when the user wears the mask, wherein when the user wears the mask, a space may be formed between the mask body and the user's face by the contact portion.

As described above, according to the present disclosure, there is provided a 3D printing-based face-shaped mask which is dustproof and capable of preventing infection with contagious bacteria while being formed in a shape identical to a human face based on 3D printing. Since the face-shaped mask has a shape and image corresponding to the user's face, the user can wear the mask without aesthetically different feeling. In addition, according to the present disclosure, it is possible to provide a mask with good aesthetics and high economic efficiency by forming a replaceable filter that does not cause visually different feeling to breathing-related parts such as the nostrils and the mouth.

### BRIEF DESCRIPTION OF THE DRAWINGS

FIG. 1 is a block diagram showing a configuration of a system for manufacturing a 3D printing-based face-shaped mask according to a preferred embodiment of the present disclosure.

FIG. 2 is a block diagram for explaining a detailed configuration of a server shown in FIG. 1.

FIG. 3 is a flowchart for explaining an operation process of the 3D printing-based face-shaped mask manufacturing system shown in FIG. 1.

FIG. 4 is a flowchart for explaining in detail a process of generating a 3D mask model shown in FIG. 3.

FIG. 5 is a perspective view schematically showing a mask body of the face-shaped mask.

FIG. 6 is a perspective view for explaining a first filter unit mounting structure formed in a nose lower part of the face-shaped mask according to one embodiment of the present disclosure.

FIG. 7 is a view showing a state in which a right nostril filter unit and a left nostril filter unit are respectively mounted to a right nostril filter unit mounting portion and a left nostril filter unit mounting portion shown in FIG. 6.

FIG. 8 is a perspective view for explaining a first filter unit mounting structure formed in a nose lower part of the face-shaped mask according to another embodiment of the present disclosure, which shows a structure in which the first filter unit is mounted based on a screw structure.

FIG. 9 is a perspective view for explaining a first filter unit mounting structure formed in the nose lower part of the face-shaped mask according to another embodiment of the present disclosure, which shows a structure in which the first filter unit is formed as a single unit.

FIG. 10 is a perspective view for illustrating a second filter unit mounting structure formed at a mouth part of the face-shaped mask according to one embodiment of the present disclosure.

FIG. 11 is a view showing a state in which the second filter unit is mounted to a second filter unit mounting portion shown in FIG. 10.

FIG. 12 is a perspective view showing a state in which an earring part is attached to the face-shaped mask.

FIG. 13 is a cross-sectional view for illustrating a contact portion formed on an inner surface of a mask body.

FIG. 14 is a perspective view for explaining a state in which a user wears the face-shaped mask according to one embodiment of the present disclosure.

FIG. 15 is a perspective view for illustrating a state in which a user wears the face-shaped mask according to another embodiment of the present disclosure.

FIG. 16 is a block diagram for showing a configuration of a system for realizing a mask manufacturing method according to another embodiment of the present disclosure.

FIG. 17 is a block diagram for explaining a detailed configuration of a server shown in FIG. 16.

FIG. 18 is a flowchart for explaining an operation process of the mask manufacturing system shown in FIG. 16.

FIG. 19 is a flowchart for explaining in detail a process of generating a 3D mask image shown in FIG. 18.

FIG. 20 shows a mask having a face display unit formed on a front surface thereof by a printer.

### DESCRIPTION OF EXEMPLARY EMBODIMENTS

The present disclosure may be changed in various ways and may have various embodiments, and specific embodiments are illustrated in the drawings and described in detail in the detailed description. However, it should be understood that the present disclosure is not intended to be limited to the specific embodiments and that the present disclosure includes all changes, equivalents and substitutions which fall within the spirit and technological scope of the present disclosure.

Terms, such as a first, a second, and the like, may be used to describe various components, but the components should not be restricted by the terms. The terms are used to only distinguish one component from another component. For example, a first element may be named a second element without departing from the scope of the present disclosure, or vice versa. The term “and/or” includes a combination of a plurality of related items or any one of the plurality of related items.

The terms in this specification are used to only describe specific embodiments and are not intended to limit the present disclosure. Singular expressions should be construed as including plural expressions unless clearly defined otherwise in the context. It is to be understood that in this specification, a term, such as “include (or comprise)” or “have”, is intended to indicate that characteristics, numbers, steps, operations, elements, parts, or a combination thereof which are described in the specification are present and does not exclude the existence or possible addition of one or more other characteristics, numbers, steps, operations, elements, parts, or a combination thereof in advance.

Hereinafter, preferred embodiments according to the present disclosure will be described in detail with reference to the accompanying drawings. In the description of the present disclosure, in order to facilitate overall understanding, the same reference numerals are used for the same components in the drawings, and redundant descriptions of the same components are omitted.

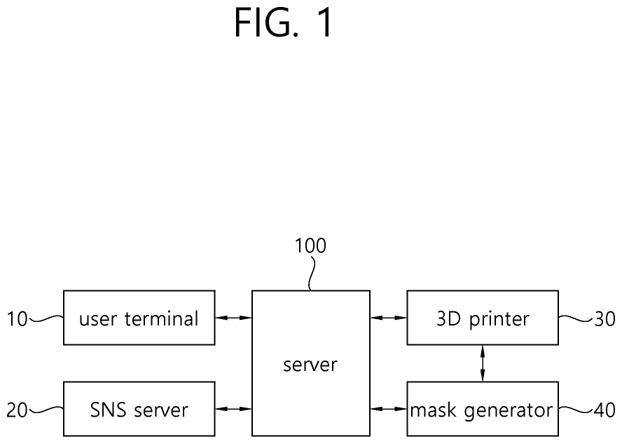

FIG. 1 is a block diagram showing a configuration of a system for manufacturing a 3D printing-based face-shaped mask according to a preferred embodiment of the present disclosure.

As shown in FIG. 1, the system may include a server 100, a 3D printer 30, a mask generator 40, and the like. The server 100 may be implemented based on one computer terminal or a plurality of computer terminals. The server 100 may interwork with the 3D printer 30 and the mask generator 40.

On the other hand, the server 100 may interwork with a user terminal 10, a social networking service (SNS) server 20, and the like through a communication network. For example, the user terminal 10 may be a user's mobile phone or PC. The SNS server 20 may be a server that operates and manages a user's SNS account. The SNS may be, for example, Instagram, Facebook, Twitter, TikTok, Kakao Page, and the like.

The server 100 may receive a plurality of 2D images obtained by capturing the user's face from the user terminal 10 or the SNS server 20, and generate a 3D mask model corresponding to a lower part shape of the user's face through 3D modeling based on the plurality of 2D images received. In this case, the 3D mask model may include at least a lower part of the nose and the mouth of the user.

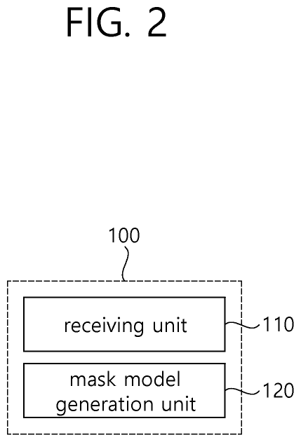

FIG. 2 is a block diagram for explaining the detailed configuration of the server 100 shown in FIG. 1, and as shown in FIG. 2, the server 100 may include a receiving unit 110 for receiving a plurality of 2D images obtained by capturing a user's face and a mask model generation unit 120 for generating a 3D mask model corresponding to the lower part shape of the user's face through 3D modeling based on the plurality of 2D images received.

The 3D printer 30 may generate a mask body corresponding to the shape of the user's lower face by performing 3D printing based on the 3D mask model generated by the server 100. In this case, the mask body may be formed to correspond to the lower part shape of the user's face, that is, to cover the lower part of the user's face in accordance with the curvature of the user's face, and an image of the lower part of the user's face may be printed and displayed on an outer surface of the mask body, that is, on the front surface of the mask. Accordingly, even when the user wears the mask, it appears as if the user is not wearing the mask. The mask body may be made of a plastic material having a predetermined elasticity while maintaining its shape.

Meanwhile, according to another embodiment of the present disclosure, the mask body covers the lower part of the user's face in accordance with the curvature of the user's face to correspond to the shape of the lower part of the user's face, and may be made of a transparent material to be transparent. For example, the mask body may be made of a transparent plastic material having a predetermined elasticity while maintaining its shape. In this case, when the user wears the mask, the mask has the same curvature as the user's face and fits the lower part of the user's face, and since the mask is transparent, the lower part of the user's face is visible, which makes it look as if the user is not wearing the mask.

The mask generation unit 40 may generate a mask corresponding to the user by mounting at least one filter unit and an earring part on the mask body. The mask generation unit 40 may include, for example, a production facility for mounting the filter unit and the earring part.

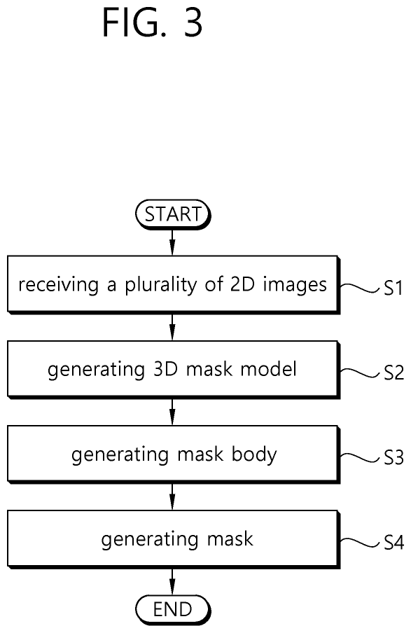

FIG. 3 is a flowchart for explaining an operation process of the 3D printing-based face-shaped mask manufacturing system shown in FIG. 1, and describes a face mask manufacturing method according to a preferred embodiment of the present disclosure.

Referring to FIGS. 1 to 3, first, the server 100 receives a plurality of 2D images obtained by capturing a user's face from at least one of the user terminal 10 and the SNS server 20 (step S1).

For example, the server 100 may receive a 2D image obtained by capturing the user's face from the user terminal 10. For example, the server 100 may receive, from the user terminal 10, a 2D image including the user's face that is captured in real time or that is previously captured and stored in the user terminal 10.

To this end, the server 100 may request a 2D image obtained by capturing the user's face to the user terminal 10. Upon request of the 2D image, the server 100 may display a user interface for selecting whether to capture in real time by activating a camera of the user terminal 10 or to select a photograph previously stored in the user terminal 10. Then, according to the user's selection, the server 100 may activate the camera capable of taking pictures in real time or display a preview list of photographs stored in the user terminal 10.

For example, the server 100 may receive a 2D image obtained by capturing the user's face from the SNS server 20 that manages the user's SNS account. For example, the server 100 may receive access information to the SNS server 20 corresponding to the account of the user from the user terminal 10, and collect a plurality of 2D images including the user's face from the SNS server 20 corresponding to the user's account. That is, the server 100 collects the user's Instagram posting photos, Facebook posting photos, Twitter posting photos, Kakao Story posting photos, and the like.

Subsequently, the server 100 may generate a 3D mask model corresponding to the shape of the lower part of the user face through 3D modeling based on the plurality of 2D images received (step S2). The 3D mask model may include at least a portion related to breathing of the user, for example, a nose lower part including nostrils, and a mouth part. The plurality of 2D images may include a front view image, a left side view image, and a right side view image of the user.

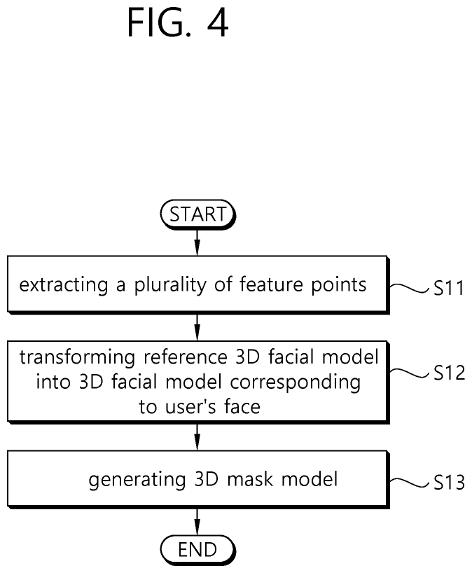

FIG. 4 is a flowchart for explaining in detail the process of generating the 3D mask model shown in FIG. 3. The operation of FIG. 4 may be performed by the mask model generation unit 120 of the server 100.

As shown in FIG. 4, first, the server 100 may extract a plurality of feature points corresponding to the face of the user from the plurality of 2D images received (step S11). For example, the server 100 may extract a plurality of feature points corresponding to the user's face by analyzing the front view image, the left side view image, and the right side view image of the user.

Subsequently, the server 100 may transform a reference 3D face model into a 3D face model corresponding to the user's face based on the plurality of feature points extracted (step S12). Accordingly, the server 100 may generate a 3D facial model corresponding to the user's face.

Next, the server 100 may generate a 3D mask model corresponding to the shape of the lower part of the face from the 3D facial model corresponding to the user's face (step S13). The 3D mask model may be a portion corresponding to a coverage of the mask in the 3D facial model of the user. For example, the 3D mask model may correspond to the lower part of the face including at least a portion related to breathing of the user, for example, a lower portion of the nose including the nostril and the mouth, in the 3D facial model.

Referring back to FIG. 3, when the 3D mask model is generated, the 3D printer 30 may generate a mask body corresponding to the shape of the lower part of the user's face based on the generated 3D mask model (step S3).

The mask body generated by the 3D printer 30 may correspond to the shape of the lower part of the user's face. For example, the mask body has the same shape as the lower part of the user's face, so that when the mask is worn, the mask body is formed to fit and cover the lower part of the user's face. In addition, the image of the lower part of the user's face may be printed and displayed on the front surface of the mask body. Accordingly, even when the user wears the mask, it appears as if the user is not wearing the mask. The mask body may be made of a plastic material having a predetermined elasticity while maintaining its shape.

Meanwhile, according to another embodiment of the present disclosure, the mask body may be formed of a transparent material. For example, the mask body has the same shape as the lower part of the user face, so that when the mask is worn, the mask body fits and covers the lower part of the user face, but since the mask body is transparent, the lower part of the user's face is visible to the outside, which makes it appears as if the user is not wearing the mask.

Next, the mask generation unit 40 may generate a mask corresponding to the user by mounting at least one filter unit and an earring part on the mask body (step S4). The mask generation unit 40 may include, for example, a production facility for mounting the filter unit and the earring part.

Hereinafter, the shape and configuration of the face-shaped mask will be described in detail.

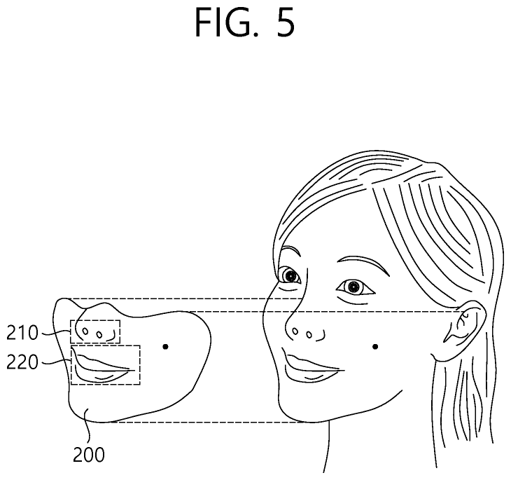

FIG. 5 is a perspective view schematically showing the mask body of the face-shaped mask.

As shown in FIG. 5, the shape of the mask body 200 may correspond to the shape of the lower part of the user's face, and the image of the lower part of the user's face may be displayed on the front surface thereof. The mask body 200 may include at least a portion related to the user's breathing, for example, a nose lower part 210 including the nostrils and a mouth part 220.

At least one filter unit mounting portion to which the filter unit can be mounted is formed on at least one side of the mask body 200. For example, the at least one filter unit mounting portion may be formed in a portion related to respiration, for example, the nose lower part 210 and the mouth part 220. In addition, an earring part for fixing to the user's ear is formed or attached to the other side of the mask body.

The filter unit is attached to a portion of the mask related to the user's breathing, and has breathability. The filter unit includes a filter that blocks at least one of droplets, yellow dust, smoke, toxic gas, fine dust, and viruses from entering a human body, and has a structure to be mounted on the filter unit mounting portion. Since the filter unit is detachably attached to the filter unit mounting portion, it can be replaced.

Hereinafter, various filter unit mounting structures of the face-shaped mask will be described in detail.

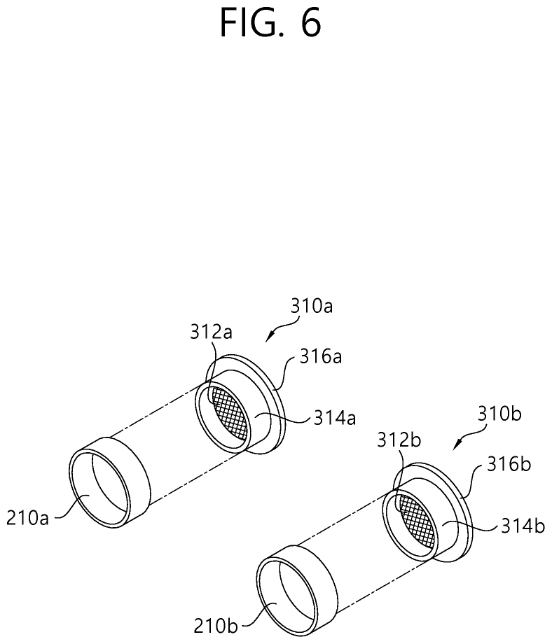

FIG. 6 is a perspective view for explaining a first filter unit mounting structure formed in the nose lower part of the face-shaped mask according to one embodiment of the present disclosure.

As shown in FIG. 6, first filter unit mounting portions 210a and 210b are formed at positions corresponding to the nostrils of the nose lower part 210 of the mask body 200. The first filter unit mounting portions 210a and 210b may include a right nostril filter unit mounting portion 210a corresponding to the right nostril and a left nostril filter unit mounting portion 210b corresponding to the left nostril. The right nostril filter unit mounting portion 210a and the left nostril filter unit mounting portion 210b are cylinders of a predetermined height formed at positions corresponding to the right nostril and the left nostril of the nose lower part 210 of the mask body 200, respectively, the cylinders each having a through-hole formed in the center thereof.

The right nostril filter unit 310a may be detachably mounted to the right nostril filter unit mounting portion 210a. The right nostril filter unit 310a may include a coupling part 314a, a hanging part 316a, and a filter 312a.

The coupling part 314a is formed in a cylinder shape to be fitted into the through-hole of the right nostril filter unit mounting portion 210a. The outer circumferential surface of the coupling part 314a may be fitted into the through-hole of the right nostril filter unit mounting portion 210a through interference fit coupling. The coupling part 314a has a through-hole for air circulation in the center. The hanging part 316a extends from the end of the coupling part 314a and has a larger diameter than the coupling part 314a. The through-hole of the coupling part 314a extends to the hanging part 316a to form an air channel through which air flows through the coupling part 314a and the hanging part 316a. In the state where the right nostril filter unit 310a is fitted into the right nostril filter unit mounting portion 210a, the hanging part 316a serves to prevent the filter unit 310a from being separated to the outside, for example, to the front side of the mask, and during replacement, the hanging part 316a serves to facilitate removal of the filter unit 310a.

The filter 312a is provided on one side of the air channel formed by the through-hole formed in the center of the coupling part 314a and the hanging part 316a, and air flowing through the air channel formed by the through-hole necessarily passes through the filter 312a. The filter 312a has breathability and can block at least one of droplets, yellow dust, smoke, toxic gas, fine dust, and viruses from entering the human body.

Like the right nostril filter unit 310a described above, the left nostril filter unit 310b may be detachably mounted to the left nostril filter unit mounting portion 210b. The left nostril filter unit 310b may include a coupling part 314b, a hanging part 316b, and a filter 312b.

The coupling part 314b is formed in a cylindrical shape to be fitted into the through-hole of the left nostril filter unit mounting portion 210b. The outer circumferential surface of the coupling part 314b may be fitted into the through-hole of the left nostril filter unit mounting portion 210b through interference fit coupling. The coupling part 314b has a through-hole for air circulation in the center. The hanging part 316b extends from the end of the coupling part 314b and has a larger diameter than the coupling part 314b. The through-hole of the coupling part 314b extends to the hanging part 316b to form an air channel through which air flows through the coupling part 314b and the hanging part 316b. In the state where the left nostril filter unit 310b is fitted into the left nostril filter unit mounting portion 210b, the hanging part 314b serves to prevent the filter unit 310b from being separated to the outside, for example, to the front side of the mask, and during replacement, the hanging part 314b serves to facilitate removal of the filter unit 310b.

The filter 312b is provided on one side of the air channel formed by the through-hole formed in the center of the coupling part 314b and the hanging part 316b, and air flowing through the air channel formed by the through-hole necessarily passes through the filter 312b. The filter 312b has breathability and can block at least one of droplets, yellow dust, smoke, toxic gas, fine dust, and viruses from entering the human body.

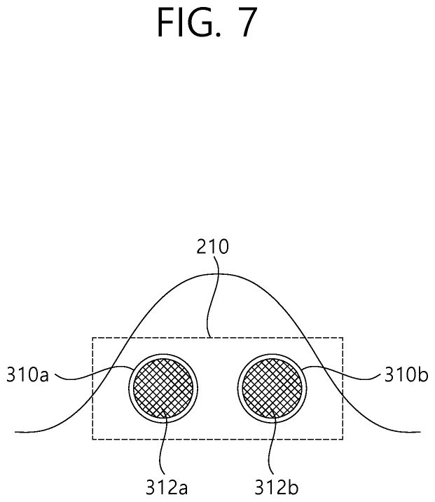

FIG. 7 shows a state in which the right nostril filter unit 310a and the left nostril filter unit 310b are respectively mounted to the right nostril filter unit mounting portion 210a and the left nostril filter unit mounting portion 21b shown in FIG. 6, and shows a view of the nose lower part 210 of the face-shaped mask in the mounted state when seen from below.

As shown in FIG. 7, by respectively fitting the right nostril filter unit 310a and the left nostril filter unit 310b into the right nostril filter unit mounting portion 210a and the left nostril filter unit mounting portion 210b in the nose lower part 210 of the face-shaped mask, the filter 312a of the right nostril filter unit 310a and the filter 312b of the left nostril filter unit 310b are exposed to the outside in terms of air flow.

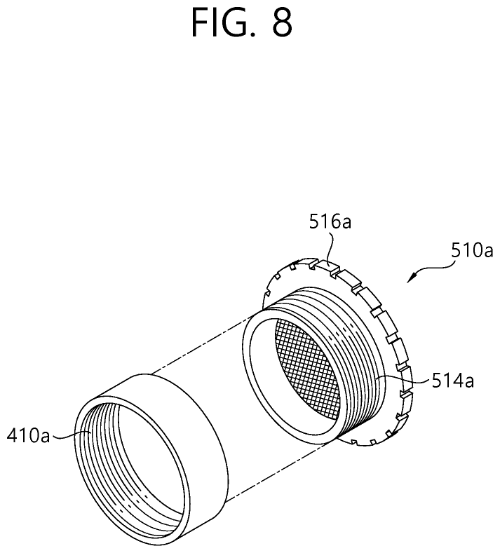

FIG. 8 is a perspective view for explaining a first filter unit mounting structure formed in a nose lower part of a face-shaped mask according to another embodiment of the present disclosure, which shows a structure in which the first filter unit is mounted based on a screw structure.

As shown in FIG. 8, a screw thread is formed on a through-hole of a right nostril filter unit mounting portion 410a, and on an outer circumferential surface of a coupling part 514a of a right nostril filter unit 510a, a screw thread matching the screw thread of the through-hole of the right nostril filter unit mounting portion 410a is formed. Accordingly, the right nostril filter unit 510a may be coupled to the right nostril filter unit mounting portion 410a through screw coupling. In addition, a plurality of grooves is formed on a hanging part 516a of the right nostril filter unit 510a to facilitate screw rotation during screw coupling.

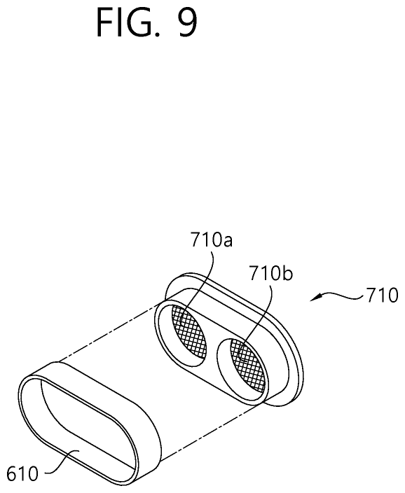

FIG. 9 is a perspective view for explaining a first filter unit a mounting structure formed in a nose lower part of a face-shaped mask according to another embodiment of the present disclosure, which shows a structure in which the first filter unit is formed as a single unit.

As shown in FIG. 9, one first filter unit mounting portion 610 is formed in a nose lower part of the face-shaped mask. The first filter unit mounting portion 610 is an elliptical cylinder of a predetermined height (i.e., a cylinder having an elliptical cross-section), and a through-hole is formed in the center thereof.

A first filter unit 710 detachably coupled to the first filter unit mounting portion 610 has a coupling part formed in an elliptical cylinder shape fitted into the through hole of the first filter unit mounting portion 610, and an outer circumferential surface of the coupling part may be fitted into the through-hole of the first filter unit mounting portion through interference fit coupling. The coupling part has two through-holes for air circulation in the center, and two filters 710a and 710b respectively corresponding to the right nostril and the left nostril are provided in the respective through-holes. In this way, when one face-shaped mask includes one first filter unit 710, the filter unit 710 can be replaced at once without the need to separately replace filter units corresponding to both nostrils, which makes the replacement easy.

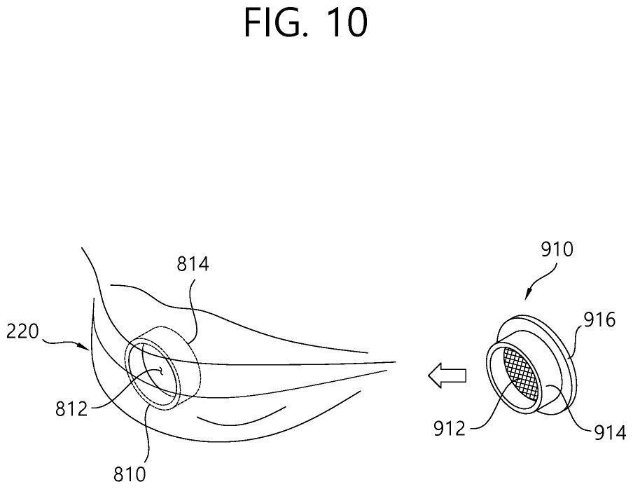

FIG. 10 is a perspective view for illustrating a second filter unit mounting structure formed at a mouth part of the face-shaped mask according to one embodiment of the present disclosure.

As shown in FIG. 10, a second filter unit mounting portion 810 is formed at a position corresponding to the mouth part 220 of the mask body. The second filter unit mounting portion 810 is a cylinder having a predetermined height, and a through-hole is formed in the center thereof. At least a portion of the through-hole may be exposed to the front surface of the mask body. The portions other than a portion 812 where the through-hole is exposed in the mouth part 220 of the mask body are all shielded. For example, the mouth part 220 of the mask body displays an image of a slightly open mouth, a lip part 814 is shielded, and the portion other than the portion where the through-hole is exposed in the open mouth portion is shielded, and for example, a tooth image may be displayed to produce a natural appearance.

A second filter unit 910 may be detachably mounted to the second filter unit mounting portion 810, and may include a coupling part 914, a hanging part 916, and a filter 912. The coupling part 914 is formed in a cylinder shape fitted into the through-hole of the second filter unit mounting portion 810. An outer circumferential surface of the coupling part 914 may be fitted into the through-hole of the second filter unit mounting portion 810 through interference fit coupling. The coupling part 914 has a through-hole for air circulation in the center thereof.

The hanging part 916 extends from the end of the coupling part 914 and has a larger diameter than the coupling part 914. The through-hole of the coupling part 914 may extend to the hanging part 916 to form an air channel through which air flows between the coupling part 914 and the hanging part 916. The hanging part 914 prevents the second filter unit 910 from being separated to the outside while being fitted into the second filter unit mounting portion 810 and facilitates the removal of the second filter unit 910.

The filter 912 is provided on one side of the air channel formed by the through-hole formed in the center of the coupling part 914 and the hanging part 916 and is exposed to the outside in terms of air flow. Air flowing through the air channel by the through-hole necessarily passes through the filter 912. The filter 912 has breathability and can block at least one of droplets, yellow dust, smoke, toxic gas, fine dust, and viruses from entering the human body.

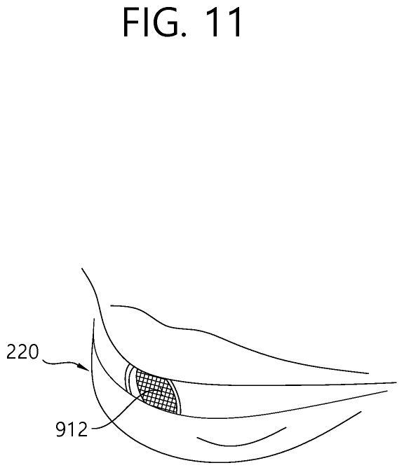

FIG. 11 is a view showing a state in which the second filter unit 910 is mounted to the second filter unit mounting portion 810 shown in FIG. 10.

As shown in FIG. 11, by fitting the second filter unit 910 into the second filter unit mounting portion 810 formed in the mouth part 220 of the face-shaped mask, at least a portion of the filter 912 provided in the through-hole of the second filter unit 910 is exposed to the outside in terms of air flow. Of the mouth part 220 of the mask body, all portions other than the portion where the filter 912 is exposed are shielded. For example, the mouth part 220 of the mask body displays an image of a slightly open mouth, and the portion where the lip image is displayed is shielded, and the remaining portion except for the portion where the through-hole is exposed is shielded in the portion where the image of the open mouth is displayed. For example, a tooth image may be displayed to produce a natural appearance.

Meanwhile, the detachable coupling of the filter unit to the filter unit mounting portion described above with reference to FIGS. 6 to 11 has been described as embodiments in which the interference fit coupling or screw coupling is applied, but according to another embodiment of the present disclosure, various types of coupling such as coupling using Velcro, sliding coupling, and snap-fit coupling between the filter unit and the filter unit mounting portion are possible.

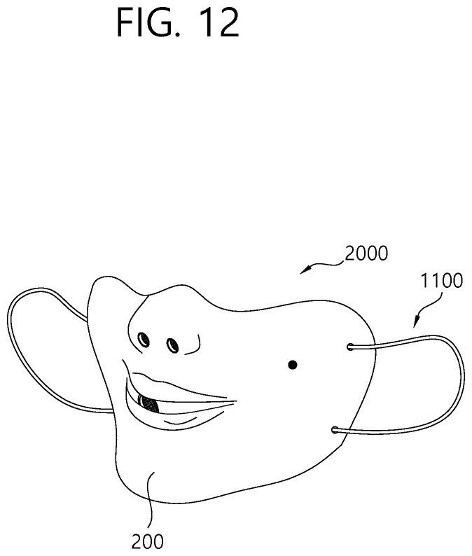

FIG. 12 is a perspective view showing a state in which an earring part is attached to the face-shaped mask. As shown in FIG. 12, earring parts 1100 for fixing the mask 2000 to the user's ears may be mounted on both side end portions of the mask body 200.

Meanwhile, on an inner surface (i.e., the surface close to the user's face) of the mask body 200, a contact portion which is in close contact with the user's face when the user wears the mask 2000 is formed along an outer peripheral surface thereof.

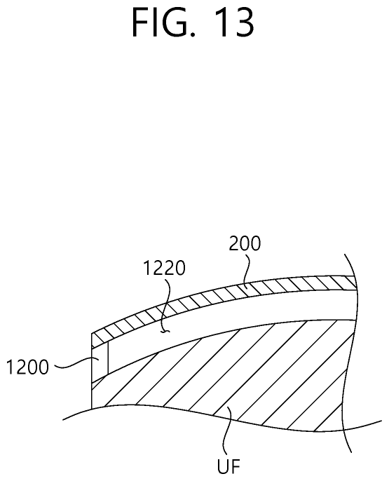

FIG. 13 is a cross-sectional view for illustrating the contact portion formed on the inner surface of a mask body.

As shown in FIG. 13, the contact portion 1200 is formed at an edge of the mask body 200. When the mask is worn, by the contact portion 1200, the mask body 200 is spaced apart from the user's face UF by a predetermined distance, and a space 1220 may be formed between the mask body 200 and the user's face UF. Accordingly, the space 1220 formed in this way can prevent the mask from interfering with the user's motions when he or she speaks or makes facial expressions.

In addition, the contact portion 1200 is formed of a material having elasticity to increase contact to the user's face UF and prevent air from flowing through any portion other than the filter unit in the mask wearing state, thereby increasing the protective effect of the mask.

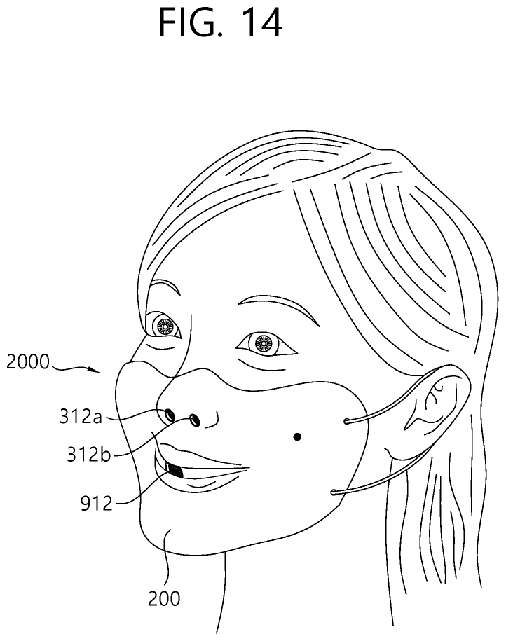

FIG. 14 is a perspective view for explaining a state in which a user wears the face-shaped mask according to one embodiment of the present disclosure.

As shown in FIG. 14, the face-shaped mask 2000 has the same shape as the shape of the lower part of the user's face, so that when the mask is worn, it fits and covers the lower part of the user's face. In addition, since the image of the lower part of the user's face is printed and displayed on the front surface of the mask body, even when the user wears the mask, the effect appears as if the user is not wearing the mask. The filters 312a, 312b, and 912 are exposed in the left and right nostrils of the noise lower part and the mouth part of the face-shaped mask in terms of air flow, so that the user can safely breathe through the filters 312a, 312b, and 912.

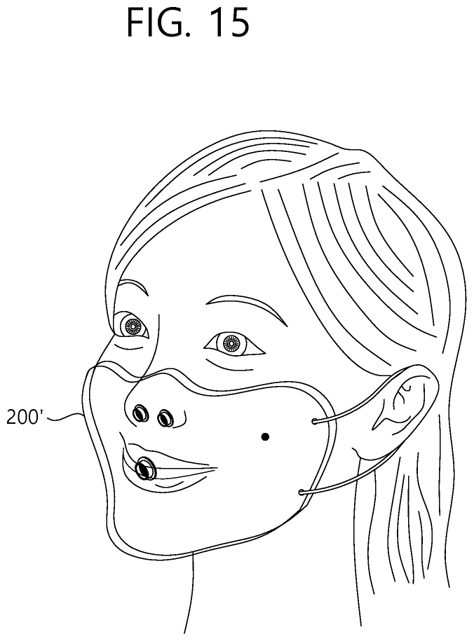

FIG. 15 is a perspective view for illustrating a state in which a user wears a face-shaped mask according to another embodiment of the present disclosure.

As shown in FIG. 15, according to another embodiment of the present disclosure, a mask body 200′ may be formed of a transparent material. For example, since the mask body 200′ has the same shape as the shape of the lower part of the user's face, the mask body 200′ fits and covers the lower part of the user's face when the user wears the mask; but since the mask body 200′ is transparent, the lower part of the user's face is seen to the outside and it appears as if the user is not wearing the mask. In the embodiment, the contact portion, the filter unit mounting portion, the filter unit, and the like of the mask may be formed of a transparent material.

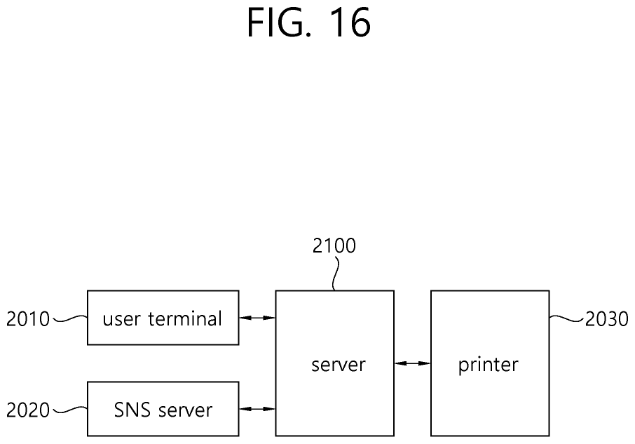

FIG. 16 is a block diagram for showing a configuration of a system for realizing a mask manufacturing method according to another embodiment of the present disclosure.

As shown in FIG. 16, the system may include a server 2100 and a printer 2030 which may interoperate with each other. The server 2100 may be implemented based on one computer terminal or a plurality of computer terminals.

Meanwhile, the server 2100 may interwork with a user terminal 2010, a social networking service SNS server 2020, and the like through a communication network. For example, the user terminal 2010 may be a user's mobile phone or PC. The SNS server 2020 may be a server that operates and manages a user's SNS account. The SNS may be, for example, Instagram, Facebook, Twitter, TikTok, Kakao Page, and the like.

The server 2100 may receive a plurality of 2D images obtained by capturing the user's face from the user terminal 2010 or the SNS server 2020, extract a plurality of 2D images associated with the user's face from the plurality of 2D images received, generate a 3D mask image corresponding to the shape of the lower part of the user's face through 3D modeling based on the plurality of 2D images extracted, and map the generated 3D mask image on a front surface of the mask. In this case, the 3D mask image includes at least the lower part of the nose and the mouth of the user and corresponds to a cover portion of the mask.

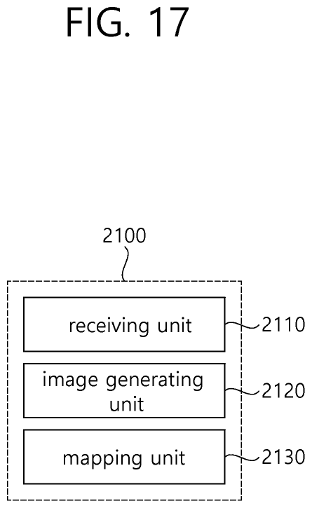

FIG. 17 is a block diagram for explaining a detailed configuration of the server shown in FIG. 16. As shown in FIG. 17, the server 2100 may include a receiving unit 2110 for receiving a plurality of 2D images obtained by capturing a user's face, an image generating unit 2120 for extracting a plurality of 2D images associated with the user's face from the plurality of 2D images received and generating a 3D mask image corresponding to the shape of the lower part of the user's face through 3D modeling based on the plurality of 2D images extracted, and an image mapping unit 2130 for mapping the generated 3D mask image to the front surface of the mask.

The printer may perform a function of forming a face display part of the mask by printing the 3D mask image mapped by the server 2100 on the front surface of the mask

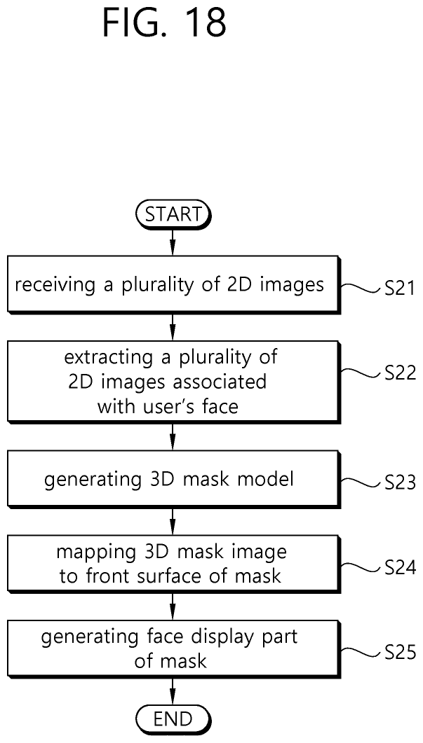

FIG. 18 is a flowchart for explaining an operation process of the mask manufacturing system shown in FIG. 16, and describes a mask manufacturing method according to another preferred embodiment of the present disclosure.

Referring to FIGS. 16 to 18, the server 2100 may receive a plurality of 2D images obtained by capturing a user's face from at least one of the user terminal 2010 and the SNS server 2020 (step S21).

For example, the server 2100 may receive a 2D image obtained by capturing a user's face from the user terminal 2010. For example, the server 2100 may receive, from the user terminal 2010, a 2D image including the user's face that is captured in real time, or that is previously captured and stored in the user terminal 2010.

To this end, the server 2100 may request a 2D image obtained by capturing the user's face from the user terminal 2010. Upon request of 2D images, the server 2100 may display a user interface for selecting whether to capture in real time by activating a camera of the user terminal 2010 or to select a photograph previously stored in the user terminal 2010. Then, according to the user's selection, the server 2100 may activate the camera capable of taking pictures in real time or display a preview list of photographs stored in the user terminal 2010.

For example, the server 2100 may receive a 2D image obtained by capturing the user's face from the SNS server 2020 that manages the user's SNS account. For example, the server 2100 may receive access information to the SNS server 2020 corresponding to the user's account from the user terminal 2010, and collect a plurality of 2D images including the user's face from the SNS server 2020 corresponding to the user's account. That is, the server 2100 collects the user's Instagram posting photos, Facebook posting photos, Twitter posting photos, Kakao Story posting photos, and the like.

Subsequently, the server 2100 may extract a plurality of 2D images associated with the user's face from the plurality of 2D images received (step S22). The plurality of 2D images may include a front view image, a left side view image, and a right side view image of the user.

The server 2100 may generate a 3D mask image corresponding to the shape of the lower part of the user's face through 3D modeling based on the plurality of 2D images extracted (step S23). Here, the 3D mask image includes at least the lower part of the nose and the mouth of the user and corresponds to the cover portion of the mask.

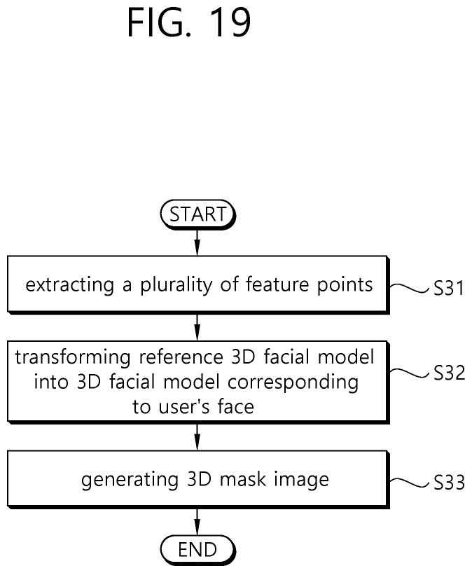

FIG. 19 is a flowchart for explaining in detail the process of generating the 3D mask image shown in FIG. 18, and the operation of FIG. 19 may be performed by the image generating unit 2120 of the server 2100.

As shown in FIG. 18, first, the server 2100 may extract a plurality of feature points corresponding to the user's face from the plurality of 2D images received (step S31). For example, the server 2100 may extract a plurality of feature points corresponding to the user's face by analyzing the front view image, the left side view image, and the right side view image of the user.

Subsequently, the server 2100 may transform a reference 3D facial model into a 3D facial model corresponding to the user's face based on the plurality of feature points extracted (step S32). Accordingly, the server 2100 may generate a 3D facial model corresponding to the user's face.

Next, the server 2100 may generate a 3D mask image corresponding to the shape of the lower part of the user's face from the 3D facial model corresponding to the user's face (step S33). The 3D mask image may be a 3D image representing the lower part of the user's face corresponding to the coverage of the mask in the 3D facial model of the user. For example, the 3D mask image may correspond to at least an image of a part related to breathing of the user, for example, the lower part of the face including a lower part of the nose including the nostrils and the mouth.

Referring back to FIG. 18, the server 2100 may map the generated 3D mask image to the front surface of the mask (step S24). The printer may generate the face display part of the mask by printing the mapped 3D mask image on the front surface of the mask using the printer (step S25).

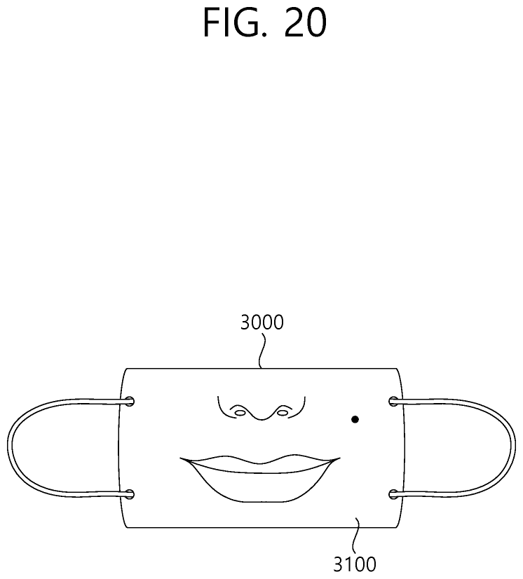

FIG. 20 shows a mask having the face display part formed on the front surface thereof by the printer.

As shown in FIG. 20, a face display part 3100 on which a 3D mask image corresponding to the shape of the lower part of the user's face including the user's nose and mouth is printed is formed on the front surface of the mask 3000. The mask has breathability and can block at least one of droplets, yellow dust, smoke, toxic gas, fine dust, and viruses from entering the human body.

Although the present disclosure has been described above by exemplifying preferred embodiments, those skilled in the art would understand that the present disclosure may be will variously modified and changed within the scope not departing from the technical details and scope of the present disclosure described in the claims below. Accordingly, the changes of the embodiments of the present disclosure will not deviate from the technology of the present disclosure.

What is claimed is:

1. A face-shaped mask comprising:
a mask body which corresponds to a shape of a lower part of a face of a user and displays the shape of the lower part of the user's face on an outer surface thereof;
at least one filter unit mounted on at least one side of the mask body; and
an earring part configured to fix the mask body to the ears of the user,
wherein the mask body is created by 3D printing based on a 3D mask model corresponding to the shape of the lower part of the user's face including a lower part of the nose and the mouth of the user, and
the at least one filter unit is mounted to correspond to at least one of the lower part of the nose and the mouth.

2. The face-shaped mask of claim 1, wherein the filter unit includes a first filter unit, and
a first filter unit mounting portion to which the first filter unit is mounted is formed at a position corresponding to at least a nostril of the mask body.

3. The face-shaped mask of claim 2, wherein the first filter unit is detachably mounted to the first filter unit mounting portion.

4. The face-shaped mask of claim 3, wherein the first filter unit is mounted on the mask body through any one of interference fit coupling, screw coupling, and sliding coupling to the first filter unit mounting portion.

5. The face-shaped mask of claim 2, wherein the first filter unit includes:
a right nostril filter unit corresponding to a right nostril of the mask body; and
a left nostril filter unit corresponding to a left nostril of the mask body, and
wherein the mask body includes:
a right nostril filter unit mounting portion for mounting the right nostril filter unit; and
a left nostril filter unit mounting portion for mounting the left nostril filter unit.

6. The face-shaped mask of claim 2, wherein the filter unit further includes a second filter unit, and
a second filter unit mounting portion for mounting the second filter unit is formed at a position corresponding to a mouth part of the mask body.

7. The face-shaped mask of claim 2, wherein the second filter unit is detachably mounted to the second filter unit mounting portion.

8. The face-shaped mask of claim 6, wherein the second filter unit is mounted on the mask body through any one of interference fit coupling, screw coupling, and sliding coupling to the first filter unit mounting portion.

9. The face-shaped mask of claim 1, wherein the at least one filter unit includes a filter, mounted on a portion related to breathing in user's face, which has breathability and blocks at least one of droplets, yellow dust, smoke, toxic gas, fine dust, and viruses from entering the body of the user.

10. The face-shaped mask of claim 1, wherein the 3D mask model is generated by the 3D modeling of receiving a plurality of 2D images obtained by capturing the user's face and converting the received plurality of 2D images into 3D images.

11. The face-shaped mask of claim 10, wherein the plurality of 2D images are received by receiving, from a user terminal, access information to a SNS server corresponding to an account of the user, and collecting the plurality of 2D images including the user's face from the SNS server corresponding to the user's account.

12. The face-shaped mask of claim 10, wherein the plurality of 2D images are received by receiving, from a user terminal, a 2D image including the user's face that is captured in real time or that is previously captured and stored in the user terminal.

13. The face-shaped mask of claim 10, wherein the plurality of 2D images include a front view image, a left side view image, and a right side view image of the user.

14. The face-shaped mask of claim 10, wherein the 3D mask model is generated by extracting a plurality of feature points corresponding to the user's face from the plurality of 2D images received, transforming a reference 3D facial model to a 3D facial model corresponding the user's face based on the plurality of feature points extracted, and separating a part corresponding to the shape of the lower part of the user's face from the 3D facial model corresponding to the user's face.

15. The face-shaped mask of claim 10, further comprising a contact portion formed along an inner peripheral surface of the mask body, the contact portion being in close contact with the user's face when the user wears the mask,
wherein when the user wears the mask, a space is formed between the mask body and the user's face by the contact portion.
